(19) United States
(12) Patent Application Publication
(10) Pub. No.: US 2026/0245317 A1
(43) Pub. Date: Aug. 20, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: SHOKO MIURA, Tokyo (JP)

(21) Appl. No.: 19/531,495

(22) Filed: Feb. 5, 2026

(30) Foreign Application Priority Data
Feb. 14, 2025 (JP) 2025-021986

(51) Int. Cl. G06T 19/00

(52) U.S. Cl. CPC G06T 19/006

(57) ABSTRACT

An information processing apparatus operating to acquire first information on a real world, acquire second information including at least information on a display right holder regarding real display information displayed in the real world, acquire third information on a request for display of virtual display information superimposed on the real display information in the real world, and determine a display requirement allowable by the display right holder for the virtual display information based on the first information, the second information, and the third information.

### BACKGROUND

### Field of the Technology

The present disclosure relates to an information processing apparatus, an information processing method, and a storage medium.

### Description of the Related Art

Mixed Reality (MR) technology is known in which an information terminal such as a head mounted display (HMD) or a smartphone superimposes virtual content, including computer graphics (CG) and text, on an image of a real world. Such virtual content may include a variety of types of advertisements.

Japanese Patent Application Laid-Open No. 2024-111549 discloses a method that associates a real world and a virtual space with each other, and displays a virtual advertisement as virtual display information at a location in the virtual space corresponding to a location in the real world.

### SUMMARY

An information processing apparatus according to one aspect of the present disclosure includes an operation to acquire first information on a real world, acquire second information including at least information on a display right holder regarding real display information displayed in the real world, acquire third information on a request for display of virtual display information superimposed on the real display information in the real world, and determine a display requirement allowable by the display right holder for the virtual display information based on the first information, the second information, and the third information.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of an application scene in a first embodiment.

FIG. 2 illustrates a hardware configuration of an information processing apparatus according to the first embodiment.

FIG. 3 illustrates a logical configuration of the information processing apparatus according to the first embodiment.

FIG. 4 is a flowchart illustrating processing executed by the information processing apparatus according to the first embodiment.

FIG. 5 illustrates an example of real advertisement information in the first embodiment.

FIG. 6 illustrates an example of a real world in the first embodiment.

FIG. 7 illustrates an example of real-world information in the first embodiment.

FIG. 8 illustrates an example of an MR advertisement display request in the first embodiment.

FIG. 9 is a flowchart illustrating determination processing in the first embodiment.

FIG. 10 is a flowchart illustrating display requirement determination processing in the first embodiment.

FIG. 11 illustrates a logical configuration of an information processing apparatus according to a second embodiment.

FIG. 12 is a flowchart illustrating processing executed by the information processing apparatus according to the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure.

### FIRST EMBODIMENT

An information processing apparatus according to a first embodiment is used by a requester who wishes a viewer wearing a display apparatus to view an advertisement as virtual space content displayed in a real world (RW) (virtual display information; referred to as “MR advertisement” hereinafter). Such a requester will be hereinafter referred to as an “MR advertisement display requester.” The MR advertisement display requester uses the information processing apparatus to obtain a display requirement for the MR advertisement. The display requirement for the MR advertisement includes a variety of conditions to be satisfied when displaying the MR advertisement in the real world, and are determined in consideration of the influence that the display of the MR advertisement has on advertisements existing in the real world (real display information; referred to as “real advertisement” hereinafter). The MR advertisement display requester who has obtained the display requirement for the MR advertisement can solicit a provider such as an advertiser who wishes to display the MR advertisement under the obtained display requirement, or can propose the display of the MR advertisement under the display requirement to a specific provider.

In the present embodiment, the real world in which the MR advertisement is displayed refers to visualization by a display apparatus such as a video see-through HMD. Alternatively, the real world may be an actual real world that is not visualized, such as one in an optical see-through display apparatus such as Augmented Reality (AR) glasses.

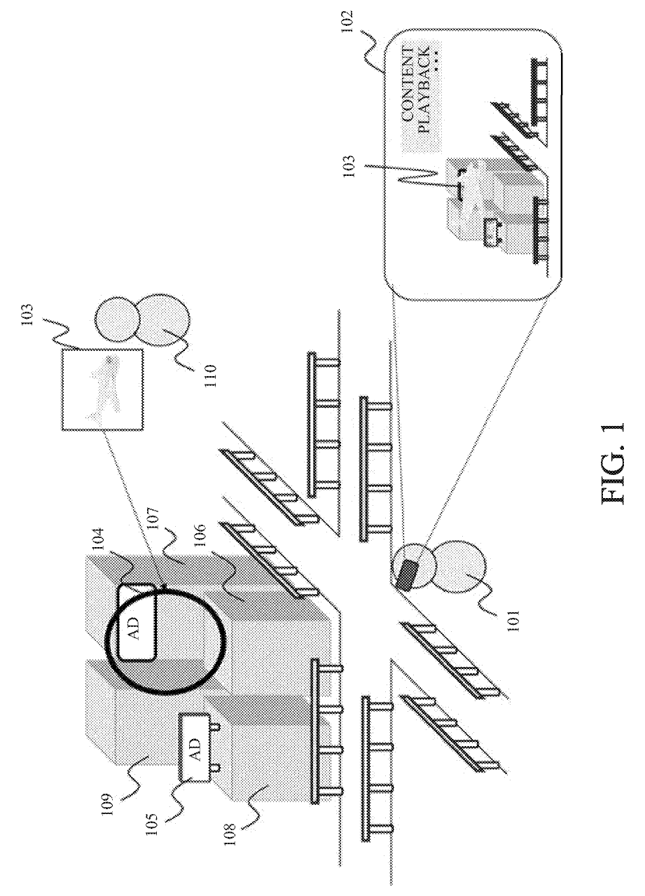

FIG. 1 illustrates an example of an application scene of the information processing apparatus in the first embodiment. The information processing apparatus includes, for example, a personal computer or a server computer, and is used by the MR advertisement display requester to obtain a display requirement for an MR advertisement.

In FIG. 1, a viewer 101 wearing an HMD is standing beside an intersection in a real world and is viewing, on an HMD screen 102, an image of the real world and virtual space content including an MR advertisement 103 superimposed thereon. In this example, the MR advertisement 103 is displayed in a real world above an actually existing building 106 within the HMD screen 102.

In the real world, a real advertisement 104 is displayed (posted) on a side surface of a building 107. A real advertisement 105 is displayed on a rooftop of a building 108. If an MR advertisement display requester 110 requests that the MR advertisement 103 be displayed in the real world above the building 106, and the MR advertisement 103 is displayed as requested, the MR advertisement 103 is superimposed on the real advertisement 104 within the HMD screen 102. That is, the display of the MR advertisement 103 affects the visibility of the real advertisement 104 to the viewer 101. In particular, when the MR advertisement is an advertisement of content different from that of the real advertisement (e.g., a different product) or is an advertisement displayed by a business entity different from that of the real advertisement, such an influence on the visibility of the real advertisement is inconvenient for advertisers and the like of the real advertisement.

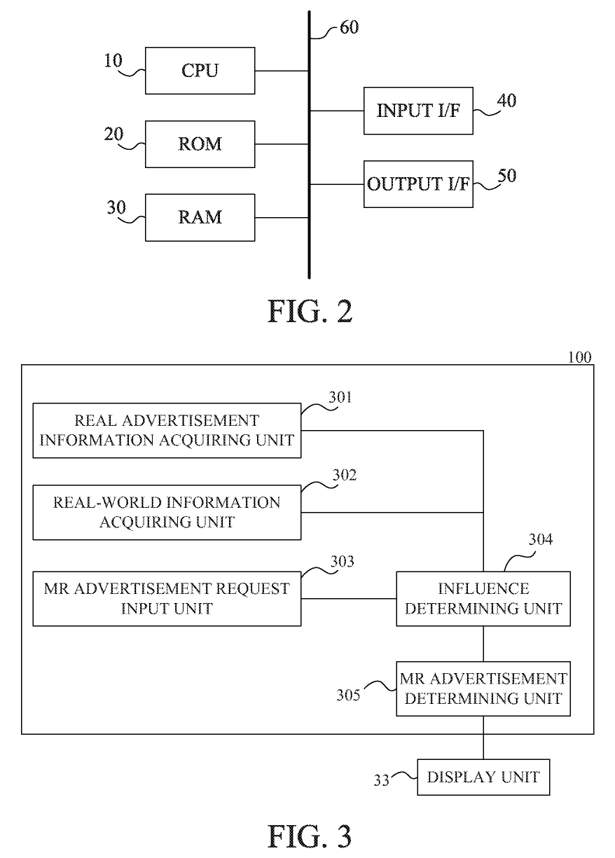

FIG. 2 illustrates a hardware configuration of the information processing apparatus 100 according to the first embodiment. The information processing apparatus 100 includes a CPU 10. The CPU 10 is connected via a bus 60 to an input I/F 40, an output I/F 50, a ROM 20, and a RAM 30. The input I/F 40 acquires input signals in a format processable by the CPU 10 from external devices (not illustrated), such as an image pickup apparatus, a display apparatus, and an input device. The output I/F 50 outputs output signals in a format processable by external devices (not illustrated), such as a display apparatus. More specifically, the information processing apparatus 100 includes one or more memories (such as the ROM 20 and RAM 30) storing instructions, and one or more processors (such as the CPU 10) that, upon execution of the instructions, operate to serve as a real advertisement information acquiring unit 301, a real-world information acquiring unit 302, an MR advertisement request input unit 303, an influence determining unit 304, and an MR advertisement determining unit 305, which will be described later.

The ROM 20 stores an operating system (OS) for operating the CPU 10, device drivers for operating the input I/F 40 and the output I/F 50, and processing programs for causing the CPU 10 to execute processing described later. The RAM 30 temporarily stores the processing programs read from the ROM 20, and the CPU 10 executes the processing described later in accordance with the processing programs stored in the RAM 30. Instead of software processing using the CPU 10, processing may be performed by hardware including a calculator and various circuits.

FIG. 3 illustrates the configuration of the information processing apparatus 100 (CPU 10) according to the first embodiment. The information processing apparatus 100 includes the real advertisement information acquiring unit 301, the real-world information acquiring unit 302, the MR advertisement request input unit 303, the influence determining unit 304, and the MR advertisement determining unit 305. The MR advertisement determining unit 305 is connected to a display unit 33. The display unit 33 is an HMD, and displays, on the HMD screen 102, an image of the real world and virtual space content as described above.

The real-world information acquiring unit 302, serving as a first acquiring unit, generates information on a real world (first information; referred to as “real-world information” hereinafter). The real-world information includes information on an owner (right holder) of the real world, such as an owner name and an ownership period (an indefinite period or a finite date or period). The owner of the real world refers to an owner of the real world itself regardless of whether objects exist therein, and includes an owner of air rights, which are rights to use a portion of a space above land.

The real-world information further includes attribute information on the real world, such as whether the real world belongs to an interior of a building or a road. The real-world information includes viewability information indicating whether a viewer is allowed to view the real world using an HMD.

The real advertisement information acquiring unit 301, serving as a second acquiring unit, generates information on real advertisements (second information; referred to as “real advertisement information” hereinafter) by acquiring such information from a requester of real advertisement display. The real advertisement information includes a display position, orientation, and size of the real advertisement, a display requester and a display right holder of the real advertisement, a display period of the real advertisement, and information on a condition under which display of an MR advertisement superimposed on the real advertisement is permitted. The real advertisement information may further include information indicating the content of the real advertisement (e.g., the type of product to be advertised).

The MR advertisement request input unit 303, serving as a third acquiring unit, acquires an MR advertisement request input by the MR advertisement display requester (third information on a request for displaying an MR advertisement in the real world). The MR advertisement request includes requests such as the position and size of a space in which the MR advertisement is to be displayed, a display method, and a display period of the MR advertisement.

The influence determining unit 304 determines whether displaying an MR advertisement in accordance with the MR advertisement request affects the visibility of a real advertisement by the viewer 101 (i.e., whether the display of the MR advertisement has an influence on the visibility of the real advertisement). An influence on the visibility of the real advertisement means a change in a viewer’s visibility state (visibility) of the real advertisement due to the display of the MR advertisement, such as the real advertisement becoming invisible or having poor visibility.

The MR advertisement determining unit 305 determines a display requirement for the MR advertisement in accordance with a determination result by the influence determining unit 304. The display requirement for the MR advertisement includes a display range as a real-world range in which the MR advertisement is displayed, a display period (such as continuous display or a limited period or time), a range of positions from which a viewer can view the MR advertisement (referred to as a “viewing range” hereinafter), and a payment (contract) condition for displaying the MR advertisement. The influence determining unit 304 and the MR advertisement determining unit 305 together constitute a determining unit.

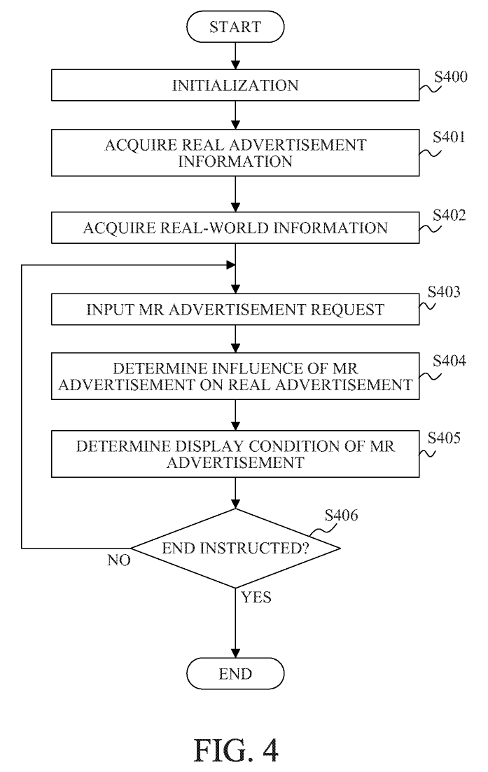

A flowchart of FIG. 4 illustrates processing (information processing method) executed by the information processing apparatus 100 used by the MR advertisement display requester in accordance with a processing program (computer program). In step S400, the information processing apparatus 100 performs initialization processing.

In step S401, the real advertisement information acquiring unit 301 acquires real advertisement information. More specifically, for each real advertisement, the real advertisement information is produced by collecting information such as the display position, orientation, size, display requester, display right holder, display period, and permission condition of the MR advertisement described above.

In step S402, the real-world information acquiring unit 302 acquires real-world information. More specifically, it collects owner information, ownership period, attribute information, and viewability information for each arbitrarily divided real world.

In step S403, the MR advertisement request input unit 303 acquires an MR advertisement request input from the MR advertisement display requester. The MR advertisement request includes, as essential items, the position and size of a space in which the MR advertisement is to be displayed and a display period, and may further include a display method such as whether the MR advertisement is displayed continuously in the same space or whether the display space moves. The request may also include a request regarding a contract condition such as a payable amount for displaying the MR advertisement.

In step S404, the influence determining unit 304 determines whether the display of the MR advertisement affects the visibility of a real advertisement based on the real advertisement information, the real-world information, and the MR advertisement request acquired in the preceding steps. In a case where it is determined that there is an influence on the visibility of a real advertisement, an influence determination result indicating the presence of an influence is generated and output in association with the permission condition of the MR advertisement in the real advertisement information corresponding to the real advertisement. Details of the influence determination processing will be described later.

In step S405, the MR advertisement determining unit 305 determines and outputs the display requirement for the MR advertisement using the influence determination result output by the influence determining unit 304. Details of the display requirement determination processing will be described later.

In step S406, the information processing apparatus 100 determines whether an instruction to end the processing has been issued, and repeats the processing from step S403 to step S405 until the end instruction is issued. When an end instruction is issued, this flow ends.

Through the above processing, the MR advertisement display requester can obtain the display requirement for the MR advertisement in consideration of the influence on the visibility of real advertisement.

Although the information processing apparatus 100 has been described as being used by an MR advertisement display requester who wishes to obtain the display requirement for the MR advertisement, the apparatus may also be used by an advertising agency or the like that contracts with the MR advertisement display requester using the obtained display requirement and receives a fee.

Processing of the steps included in the flowchart of FIG. 4 and other flowcharts described later may be collectively performed as a single step, or processing of each step may be further divided into a plurality of finer steps.

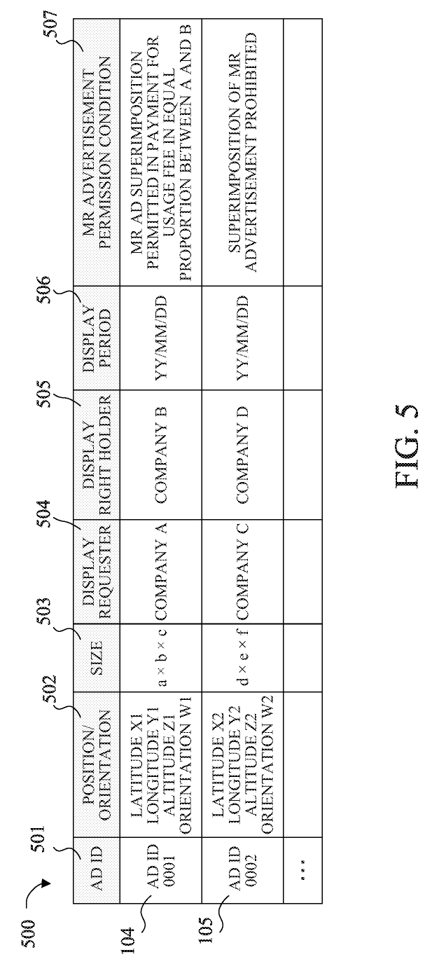

FIG. 5 illustrates an example of real advertisement information 500. The real advertisement information 500 includes, for each real advertisement, an advertisement ID 501, a display position and orientation 502, a display size 503, a display requester 504, a display right holder 505, a display period 506, and MR advertisement permission condition 507.

The display position represents a position at which the real advertisement is to be displayed, expressed by latitude, longitude, and altitude. The display orientation is expressed by a direction. The display size 503 represents the size (shape) of the displayed real advertisement as a rectangular solid of width a × height b × depth c. In a case where the real advertisement cannot be represented as a rectangular solid, a rectangular solid enclosing the real advertisement is defined and the size of the rectangular solid is calculated.

The display right holder 505 is a person who holds the right to display the real advertisement at the display position, and includes, for example, a business entity that owns an advertising sign installed on a rooftop of a building and solicits advertisements to be displayed on the sign. The display requester 504 is a person (e.g., an advertiser) who requests the display of the real advertisement from the display right holder 505.

The display period 506 is a period or date (such as a start date) during which the real advertisement is displayed.

The MR advertisement permission condition 507 is a condition for permitting the display of an MR advertisement superimposed on the real advertisement at the same position as the real advertisement displayed by the display requester 504. More specifically, the condition includes a fee-related condition such as permitting superimposed display of an MR advertisement on the real advertisement when a usage fee is paid to both or either of the display requester 504 and the display right holder 505. The condition may include a fee amount and a payment ratio to the display requester 504 and the display right holder 505. In a case where the display requester 504 and the display right holder 505 are the same person and superimposed display of an MR advertisement on the real advertisement is not permitted regardless of a condition, the MR advertisement permission condition 507 may indicate non-permission. The MR advertisement permission condition 507 may further include a condition relating to display time, such as permitting superimposed display only within a certain time period in a day, or a condition relating to a viewing range, such as permitting display of an MR advertisement only at a position or size that has little influence on a viewer’s visibility of the real advertisement.

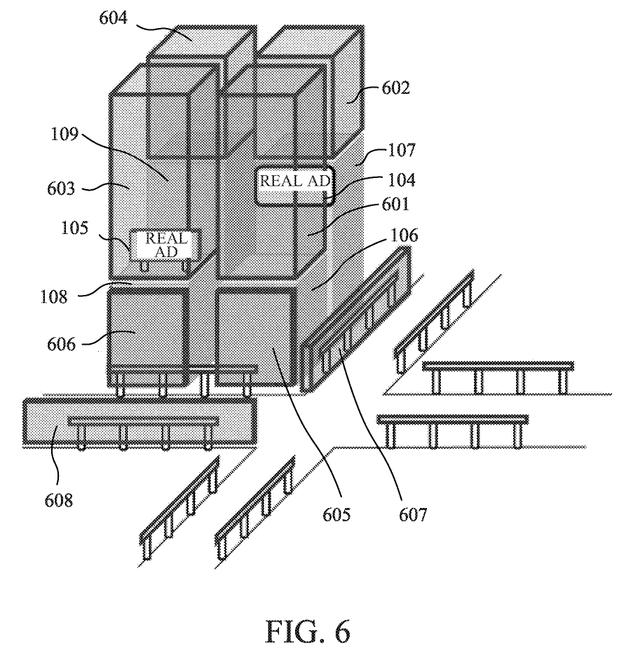

FIG. 6 illustrates examples of a variety of real worlds in the present embodiment. A real world 601 is a space above the building 106, a real world 602 is a space above the building 107, a real world 603 is a space above the building 108, and a real world 604 is a space above the building 109. A real world 605 is a space in front of the building 106, and a real world 606 is a space in front of the building 108. Real worlds 607 and 608 are spaces corresponding to sidewalk portions facing a road.

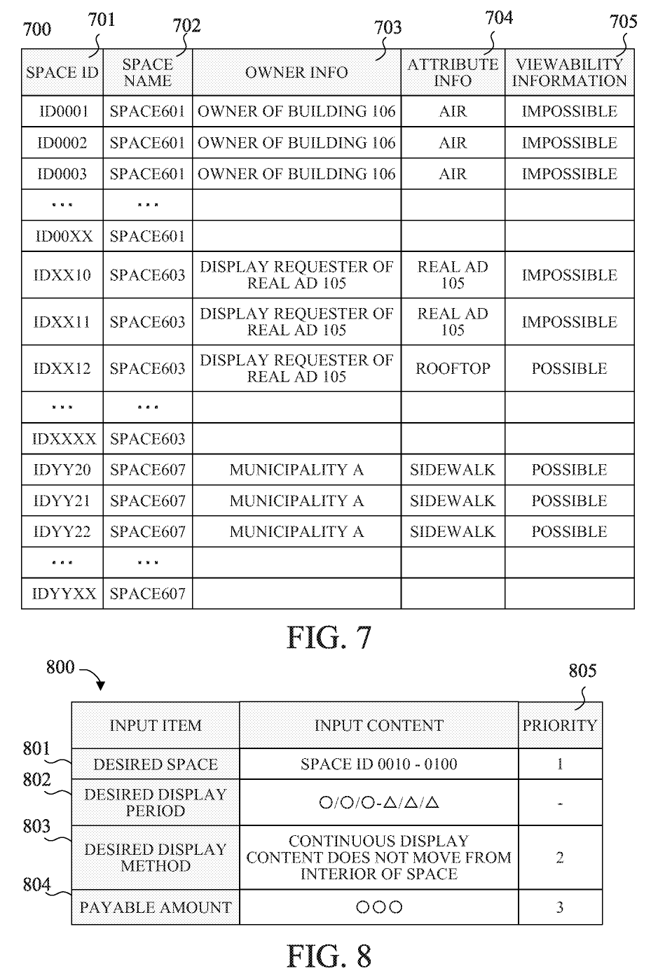

FIG. 7 illustrates an example of real-world information 700 acquired by the real-world information acquiring unit 302 in the present embodiment. The real-world information 700 includes space identification information (referred to as a “space ID” hereinafter) 701, a space name 702, owner information 703, attribute information 704, and viewability information 705. The real-world information 700 is specified by using a space ID 701, which is identification information that is assigned by partitioning a real world and is not duplicated among all partitioned spaces. As the space ID 701, information that has been predefined and stored in a database is used.

The owner information 703 indicates an owner of the real world. In a case where ownership of land or a building associated with the real world is clear, the owner of the land or building is regarded as being the same as the owner of the real world, and such owner is indicated. In a case where the owner of the land associated with the real world differs from the owner of the real world, the owner information 703 indicates the owner of the real world rather than the landowner. For a real world that is not owned by an individual, such as a public road, but is owned by a municipality that has authority over the real world, the owner information 703 includes information indicating that municipality.

For example, the owner of the real world 601 illustrated in FIG. 6 is the owner of the building 106. The real world 603 is a space above the building 108, but its owner is not the owner of the building 108, and is instead the display requester of the real advertisement 105. The real world 607, which is a space above a sidewalk, is space managed by municipality A. Therefore, the owner of the real world 607 is municipality A.

The attribute information 704 of a real world indicates “air” for a real world that is a space above a building, and indicates “rooftop,” “sidewalk,” or the like for an area such as a rooftop or a sidewalk into which people can enter. In addition, when a real advertisement exists in the real world, the attribute information 704 indicates “real advertisement.”

The viewability information 705 indicates whether a viewer can view an image through an HMD from the real world (that is, whether the viewer is allowed to enter the real world).

FIG. 8 illustrates an example of an MR advertisement request 800 input to the MR advertisement request input unit 303 by an MR advertisement display requester in the present embodiment. The MR advertisement request 800 includes a desired space 801 for which the display requirement of an MR advertisement is to be obtained, a desired period 802 during which the MR advertisement is to be displayed, a desired MR advertisement display method 803, a payable amount 804, and a priority 805 of these items. In the example illustrated in FIG. 8, displaying an MR advertisement using desired spaces with space IDs 0010 to 0100 is set as the highest priority, and a display method of continuously displaying the MR advertisement without moving it from the desired space during the desired display period is set as the second highest priority. A payable amount is input as a lower-priority item than those.

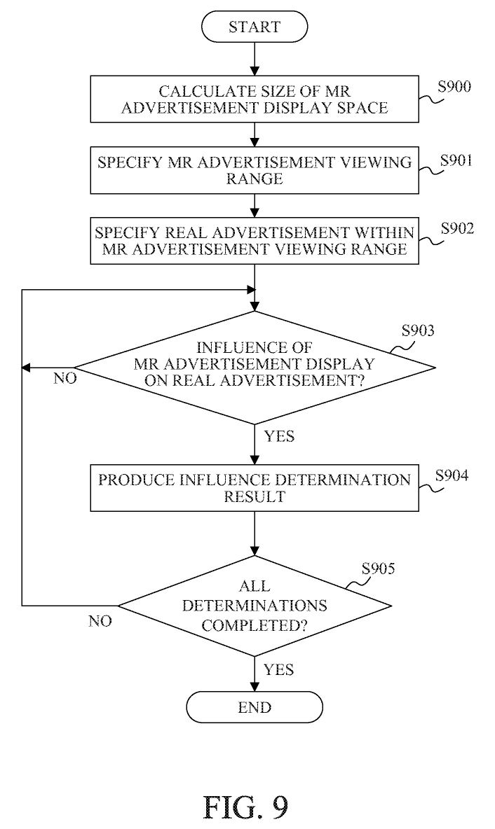

A flowchart of FIG. 9 illustrates details of influence determination processing in step S404 of FIG. 4. In step S900, the influence determining unit 304 obtains, for example, a position and size of a real world 601 in FIG. 6 as a desired space in which an MR advertisement is to be displayed. More specifically, the influence determining unit 304 calculates the position and size of the real world 601 based on position information on the space ID 701 of the real world 601 included in the real-world information 700 acquired by the real-world information acquiring unit 302, and the number of the space IDs. At this time, for example, when the shape of the real world 601 is represented by a rectangular solid, the size is calculated as a length, a width, and a height of the rectangular solid. In a case where the shape of the real world 601 is represented by a sphere or an ellipsoid, a radius of the sphere or lengths of a major axis and a minor axis of the ellipsoid are calculated. In a case where the shape of the real world 601 is a triangular pyramid or another special shape, the shape may be approximated by an ellipsoid to calculate the size.

Next, in step S901, the influence determining unit 304 identifies a range in which a viewer can visually recognize the MR advertisement when the MR advertisement is displayed in the desired space (referred to as an “MR advertisement viewing range” hereinafter). The MR advertisement viewing range can be identified by calculating a distance at which a viewer can visually recognize the MR advertisement on an HMD screen (hereinafter referred to as a “visible distance”) with respect to the position and size of the real world 601 obtained in step S900. The visible distance for a human as a viewer for an object is a distance at which the object can be rendered on the HMD screen at a size visually recognizable by the viewer. More specifically, a visually recognizable object size on the HMD screen is first defined, and then a distance at which an object is rendered at that size is calculated as the visible distance.

That is, based on a focal length f of the HMD, a size s of an object on the HMD screen, and an actual size S of the object, the visible distance D can be calculated as D = S×f/s. The MR advertisement viewing range is defined as an interior of a cylindrical region having, as a radius, the visible distance D from a center point of the desired space. Alternatively, the MR advertisement viewing range may be defined as the interior of a spherical region having the visible distance D as a radius.

Next, in step S902, the influence determining unit 304 identifies, from the real advertisement information acquired by the real advertisement information acquiring unit 301, one or more real advertisements that exist within the MR advertisement viewing range identified in step S901 (referred to as “visible real advertisements” hereinafter). The visible real advertisement is identified as follows.

First, the influence determining unit 304 identifies one or more space IDs included in the MR advertisement viewing range from the real-world information. Next, among the identified space IDs, a space ID whose attribute information indicates the “real advertisement” is extracted. For example, in a case where the MR advertisement viewing range is identified so as to include up to the opposite side of the intersection in the real world 601 where the viewer 101 illustrated in FIG. 1 is standing, the real advertisements 104 and 105 are identified as visible real advertisements from the real advertisement information.

Next, in step S903, the influence determining unit 304 determines whether displaying the MR advertisement 103 in the real world 601 illustrated in FIG. 6 affects (changes) the visibility of the visible real advertisements 104 and 105 by a viewer viewing them within the MR advertisement viewing range. Whether there is an influence on the visibility of a visible real advertisement can be determined by determining whether the MR advertisement is superimposed in front of the visible real advertisement. In other words, the determination can be made based on whether a viewer’s line of sight when viewing the visible real advertisement passes through the real world 601 in which the MR advertisement is displayed. Information on the viewer’s line of sight and a determination result as to whether the line of sight passes through the real world 601 in which the MR advertisement is displayed (i.e., whether the display of the MR advertisement influences the visibility of the real advertisement) corresponds to information on the influence.

More specifically, first, a viewer position within the MR advertisement viewing range (referred to as a “viewing position” hereinafter) is identified by extracting space IDs whose viewability information included in the real-world information indicates “possible (i.e., viewable).” A viewing position is, for example, a center of a bottom surface of a real world corresponding to an extracted space ID. A viewer’s line of sight toward the real advertisement 104 from a viewing position can be calculated based on the viewing position and coordinates indicating the position of the real advertisement 104.

The coordinates of the real advertisement 104 are calculated based on a position, orientation, and size of the real advertisement 104. More specifically, a center position of the real advertisement 104 is calculated from coordinates indicating the position of the real advertisement 104, and a display range in which the real advertisement 104 is displayed is identified based on the orientation and size with respect to the center position. Then, one or more space IDs in the spatial region included in the display range are obtained, and a center position of each spatial region (referred to as a “real advertisement region” hereinafter) is defined as a coordinate of the real advertisement 104.

The influence determining unit 304 calculates a viewer’s line of sight toward the real advertisement 104 for all combinations of viewing positions and coordinates of the real advertisement 104 (one or more real advertisement regions). Then, the influence determining unit 304 determines whether a distance between a coordinate of a center position of each real advertisement region and a corresponding line of sight is equal to or less than half the size of the real advertisement region, and determines that the line of sight passes through the real advertisement region when the condition is satisfied. In a case where it is determined that the line of sight passes through at least one real advertisement region, it is determined that the line of sight passes through the real world 601. The influence determining unit 304 determines that there is an influence on the visibility of the real advertisement 104 for a viewing position at which the line of sight passes through the real world 601. The influence determining unit 304 performs the above determination for all viewing positions.

In step S903, in a case where the influence determining unit 304 determines that there is an influence on the visibility of a real advertisement, the influence determining unit 304 performs processing of step S904. In a case where it is determined that there is no influence, the influence determining unit 304 performs the processing of step S903 for another visible real advertisement.

In step S904, the influence determining unit 304 generates an influence determination result in which a determination result obtained in step S903 is associated with the MR advertisement permission condition and an MR advertisement request.

Next, in step S905, the influence determining unit 304 determines whether the processing of step S903 and step S904 has been performed for all visible real advertisements identified in step S902 (for example, real advertisements 104 and 105). In a case where the processing has been performed for all such real advertisements, this flow ends.

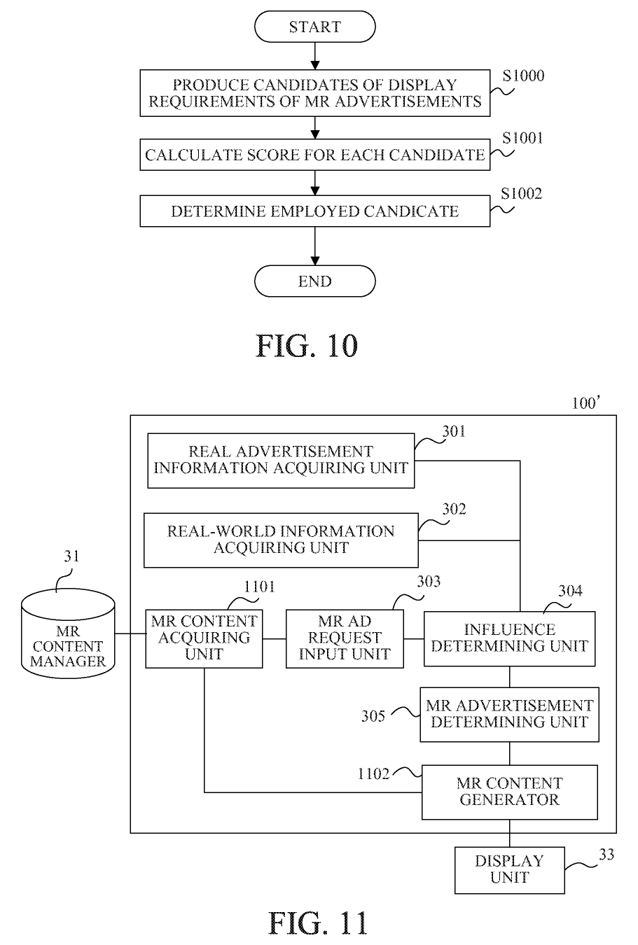

A flowchart of FIG. 10 illustrates details of display requirement determination processing in step S405 of FIG. 4. In step S1000, the MR advertisement determining unit 305 generates candidates for display requirements of MR advertisements. The display requirement of the MR advertisement is determined based on the above-described display range of the MR advertisement, a viewing range in which a viewer is located, and a contract condition among an MR advertisement display requester, a real advertisement display requester, and an owner of a real world. More specifically, eight types of candidates are generated from combinations of presence or absence of display range limitations, presence or absence of viewing range limitations, and presence or absence of a contract condition.

Candidate 1 is a display requirement that satisfies all MR advertisement requests without any contract conditions. Candidate 2 is a display requirement that satisfies all MR advertisement requests while a contract condition is provided. Candidate 3 is a display requirement in which, without contract conditions, the MR advertisement is displayed in a desired space (display range) included in the MR advertisement request, limited to a viewing range that does not affect the visibility of real advertisements. Candidate 4 is a display requirement in which, while a contract condition is provided, the MR advertisement is displayed in a desired space included in the MR advertisement request, limited to a viewing range that does not affect the visibility of real advertisements. Candidate 5 is a display requirement in which, without contract conditions, the MR advertisement is displayed without limiting the viewing range, but limited to a display range that does not affect the visibility of real advertisements. Candidate 6 is a display requirement in which, while a contract condition is provided, the MR advertisement is displayed without limiting the viewing range, but is limited to a display range that does not influence the visibility of real advertisements. Candidate 7 is a display requirement in which, without contract conditions, the MR advertisement is displayed while being limited to both a display range and a viewing range that do not influence the visibility of real advertisements. Candidate 8 is a display requirement in which, while a contract condition is provided, the MR advertisement is displayed while being limited to both a display range and a viewing range that do not influence the visibility of real advertisements.

In step S1001, the MR advertisement determining unit 305 calculates a score for each of the candidates of the display requirements generated in step S1000. The score is calculated according to a calculation method based on the MR advertisement permission condition and MR advertisement request associated with the influence determination result generated in step S904.

Here, a deduction-based scoring method will be described. First, a reference score is set for each of the MR advertisement display range, the viewing range, and the contract condition. Then, in a case where a display requirement violates the MR advertisement permission condition, points are deducted from the reference score. In addition, a greater number of points is deducted for items that violate higher-priority items in the MR advertisement request.

For example, a reference score for each of the display range, viewing range, and contract conditions is set to 10 points, a deduction of -6 points is applied when violating the MR advertisement permission condition, and deductions of -5 points, -3 points, -2 points, and -1 point are applied in descending order of priority of violated items in the MR advertisement request. For example, candidate 1 may have a score of 13 points, candidate 2 may have 18 points, candidate 3 may have 16 points, candidate 4 may have 21 points, candidate 5 may have 14 points, candidate 6 may have 19 points, candidate 7 may have 17 points, and candidate 8 may have 22 points. The scoring method for each candidate is not limited to this example.

Next, in step S1002, the MR advertisement determining unit 305 determines the display requirement of the MR advertisement to be employed using the score calculated in step S1001. More specifically, the candidate having the highest score is determined as the display requirement of an MR advertisement. In the above score example, candidate 8 is determined as the display requirement of an MR advertisement. That is, the MR advertisement can be superimposed on the real advertisement 104 by paying usage fees to both the display requester and the display right holder of the real advertisement 104. The amounts of the usage fees paid to the display requester and the display right holder of the real advertisement 104 are equal, in accordance with the MR advertisement permission condition. When viewed from a viewing range that does not affect the visibility of the real advertisement 105 by viewers, the MR advertisement can be displayed in the real world 602. In a case where the visibility of the real advertisement 105 by viewers may be affected, the MR advertisement can be displayed while being limited to a viewing range within the real world 602, which does not affect the visibility of the real advertisement 105.

According to the present embodiment described above, an MR advertisement display requester can obtain a display requirement of an MR advertisement in consideration of the influence on the visibility of real advertisements caused by the display of the MR advertisement.

### MODIFICATION 1-1

In step S1000 of FIG. 10, the MR advertisement determining unit 305 does not necessarily have to generate eight candidates for the display requirement of an MR advertisement, and may generate a smaller number or a larger number of candidates. For example, a display requirement aiming at a synergistic advertising effect by allowing viewers to view both real advertisements and MR advertisements may be included as a candidate. Alternatively, a display requirement in which an MR advertisement moving within a desired space is intermittently superimposed on a real advertisement at a predetermined cycle rather than continuously may be included as a candidate. In such a case, a score of the candidate may be determined based on a ratio of time during which the MR advertisement is superimposed. Candidates may be generated using generative AI. The display requirement of the MR advertisement generated by generative AI may be presented to an MR advertisement display requester to allow the requester to select whether to adopt them.

Instead of adopting, as a display requirement of an MR advertisement, a candidate having the highest score among a plurality of scored candidates, only a candidate that matches the MR advertisement permission condition may be selected. In a case where the candidates cannot be narrowed down to one, the MR advertisement display requester may be allowed to select a candidate.

The method of scoring each candidate is not limited to a deduction-based method in which points are deducted when violating the MR advertisement request or MR advertisement permission condition, and may be an addition-based method or a division-based method. In the addition-based method, points may be added when the MR advertisement request and MR advertisement permission condition are satisfied, or the added points may be varied according to priorities in the MR advertisement request.

Scores may be calculated by assigning weights according to the priorities of items in the MR advertisement request. Alternatively, scores may be determined based on a proportion of a viewing range that causes an influence on the visibility of real advertisements. Since an influence on the visibility of real advertisements from viewing positions where viewers are likely to gather has a greater impact on the advertising effects of the real advertisements, weights may be assigned to viewing positions for each advertising effect of the real advertisement, and a degree of influence may be calculated and reflected in the score.

The first embodiment determines the display requirement of the MR advertisement without considering the influence on real advertisements with respect to advertisement content or advertisement providers caused by the display of the MR advertisements. Alternatively, the display requirement of the MR advertisement may be determined based on the determination result regarding influences on advertisement content or advertisement providers of real advertisements caused by the display of MR advertisements. For example, in a case where it is determined that the display of an MR advertisement causes an adverse influence on advertisement content or an advertiser of a real advertisement, the display requirement of the MR advertisement may be restricted so as to eliminate or reduce such adverse influence. Conversely, in a case where it is determined that the display of an MR advertisement causes a beneficial influence on advertisement content or an advertiser of a real advertisement due to synergistic effects between the advertisements, the display requirement of the MR advertisement may be determined so as to enhance such beneficial influence. In such cases, information on advertisement content or advertisers of the MR advertisement may be included in the MR advertisement request. The display requirement of the MR advertisement that considers influences on advertisement content or advertisers of real advertisements includes not only a condition for superimposing the MR advertisement on the real advertisement, but also a condition for displaying the MR advertisement in the real world adjacent to the real advertisement.

The display requirement of the MR advertisement may be determined based on real-world information, real advertisement information, and MR advertisement requests without performing processing for determining influences on the visibility of real advertisements (and further influences relating to advertisement content or providers) as in the first embodiment. In this case, the information on the influence may be obtained from relationships among the real-world information, the real advertisement information, and the MR advertisement requests, and the display requirements of MR advertisements may be determined based on such information. For example, attribute information on a real world in which display of an MR advertisement is requested and real advertisement information displayed therein may be used as the information on the influence to determine display requirements of the MR advertisement.

The information processing apparatus 100 according to the first embodiment may be used by an MR advertisement display requester who only desires to obtain the display requirement of an MR advertisement without performing the display of the MR advertisement. In such a case, information that limits entities who can use the determined display requirement may be included in the display requirement.

In the first embodiment, a display requester of an MR advertisement assigns priorities to items such as a desired space for displaying an MR advertisement, a desired period, a desired display method, and a payable amount in an MR advertisement request. However, priorities may not be assigned to items that are not of high priority. For items to which priorities are not assigned, the MR advertisement determining unit 305 may determine priorities.

### MODIFICATION 1-2

The real advertisement information acquiring unit 301 may acquire real advertisement information that has been registered in advance in a database by a display requester of a real advertisement, or may acquire real advertisement information by performing image recognition processing on images obtained by imaging real advertisements currently being displayed using a camera mounted on an HMD. Alternatively, real advertisement information may be acquired by performing image recognition processing on images obtained by another image pickup apparatus such as a surveillance camera. In this case, information on a position, an orientation, a size, and a display requester of a real advertisement can be acquired.

The real advertisement information acquiring unit 301 may acquire real advertisement information while limiting the positions of real advertisements for which the real advertisement information is to be acquired.

The first embodiment uses the latitude, longitude, and altitude as the position of a real advertisement. However, similarly to the real-world information, a space ID or an address may be used as the position of a real advertisement. An orientation may also be added to the position of the real advertisement. The orientation of the real advertisement is a factor for determining whether a viewer can view the real advertisement from a viewing position. Since viewing positions include various locations such as rooftops of buildings as well as ground-level locations, the orientation of the real advertisement can be utilized to determine whether the real advertisement can be viewed.

### MODIFICATION 1-3

The influence determining unit 304 may define a viewing range in which an MR advertisement 103 is visible as a range other than an interior of a cylindrical range having the above-described recognition distance as a radius. For example, information on viewing positions where people are likely to visually observe surroundings, such as rooftops of buildings and windows of buildings within the viewing range, may be collected in advance, and it may be determined whether the display of the MR advertisement influences the visibility of real advertisements for each viewing position within the viewing range. In a case where there is an influence on the visibility of a real advertisement at even one viewing position within the viewing range, the viewing range may be determined as having an influence on the visibility of real advertisements due to the display of the MR advertisement.

The influence determining unit 304 may not determine whether there is an influence on the visibility of a real advertisement due to the display of an MR advertisement based solely on whether a viewer’s line of sight passes through the space in which the MR advertisement is displayed. For example, in a case where a tilt of a line of sight passing through the space in which the MR advertisement is displayed is extremely large, it may be difficult to visually recognize the real advertisement as well. Therefore, a field angle in which the real advertisement can be visually recognized relative to an orientation of the real advertisement may be defined, and it may be determined whether a line of sight within the field angle passes through the space in which the MR advertisement is displayed.

The influence determining unit 304 may exclude viewing positions that are excessively close to a real advertisement from a viewing range for the real advertisement. As in the real advertisement 105 illustrated in FIG. 6, even when a viewer attempts to view a real advertisement installed on a rooftop of a building from a position immediately in front of the building 108, the building 108 blocks the line of sight and the real advertisement 105 cannot be viewed. Thus, viewing positions at which an inclination of a line of sight becomes extremely large also in a height direction may be excluded from the viewing range. In this case, a radius of a range of viewing positions to be excluded may be calculated, and a viewing range excluding a central portion having the radius may be obtained.

The influence determining unit 304 may calculate lines of sight using methods other than calculating lines of sight to coordinates of centers of real advertisement regions identified by space IDs. For example, in a case where a real advertisement has a polygonal shape, lines of sight to coordinates of vertices of the polygon may be calculated. Alternatively, a bounding box having a size capable of enclosing the real advertisement may be defined, and lines of sight to coordinates of the vertices of the bounding box may be calculated.

### MODIFICATION 1-4

The influence determining unit 304 may acquire real-world information using methods other than using space IDs. For example, real worlds such as real worlds 601 to 607 illustrated in FIG. 6 may be defined as spaces having predetermined sizes. In this case, the vertex coordinates of each space, the reference coordinate, and the size (length, width, and height) of the space may be acquired as real-world information.

### MODIFICATION 1-5

The MR advertisement determining unit 305 may determine, as one of the display requirements of MR advertisements, a contract condition other than paying equal usage fees to a display requester of a real advertisement 104 and a display right holder thereof. For example, it may determine that a usage fee is also paid to an owner of a real world in which the real advertisement is displayed, in addition to the display requester and the display right holder of the real advertisement. In this case, the usage fees may be determined according to preferences of the display requester of the real advertisement, the display right holder, the owner of the real world, and the MR advertisement display requester.

### SECOND EMBODIMENT

Next, a second embodiment will be described. The first embodiment determines display requirements of MR advertisements in consideration of an influence on the visibility of real advertisements. On the other hand, in the second embodiment, an MR advertisement is created in advance as virtual space content (referred to as “MR content” hereinafter), and an MR advertisement display requester who knows specific content of the MR advertisement uses an information processing apparatus.

FIG. 11 illustrates a system configuration including an information processing apparatus 100′ according to the second embodiment. Among components of the present embodiment, components identical to those of the first embodiment will be designated by the same reference numerals. The information processing apparatus 100′ is configured by adding an MR content acquiring unit 1101 and an MR content generator 1102 to the information processing apparatus 100 according to the first embodiment. Therefore, the information processing apparatus 100′ includes one or more memories (such as the ROM 20 and RAM 30) storing instructions, and one or more processors (such as the CPU 10) that, upon execution of the instructions, operate to serve as the real advertisement information acquiring unit 300, the real-world information acquiring unit 302, the MR advertisement request input unit 303, the influence determining unit 304, the MR advertisement determining unit 305, the MR content acquiring unit 1101, and the MR content generator 1102.

The MR content acquiring unit 1101 is connected to an MR content manager 31 that is provided separately from the information processing apparatus 100′ and manages MR content, and acquires an MR advertisement as MR content from the MR content manager 31. The MR content generator 1102 serving as a generator generates MR content to be displayed on an HMD by modifying the MR advertisement acquired by the MR content acquiring unit 1101 in accordance with the display requirement of the MR advertisement determined by the MR advertisement determining unit 305.

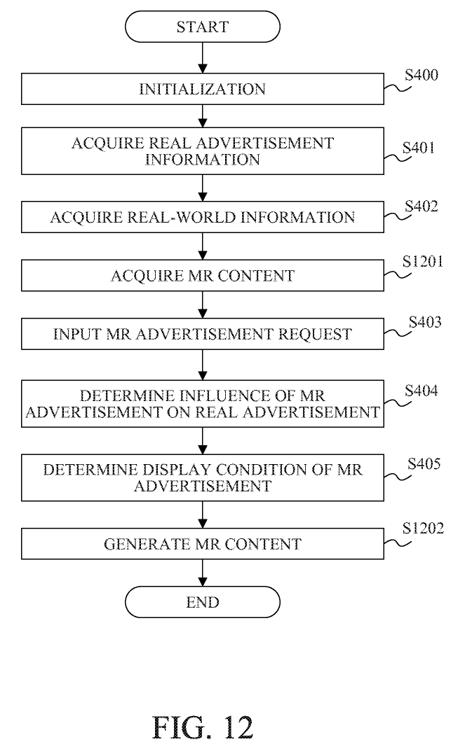

A flowchart of FIG. 12 illustrates processing (an information processing method) executed by the information processing apparatus 100′ in accordance with a processing program (computer program). In the flowchart, steps identical to those in the flowchart of the first embodiment (FIG. 4) will be designated by the same reference numerals.

In step S1201 after processing of steps S400 to S402 is performed, the MR content acquiring unit 1101 acquires, from the MR content manager 31, an MR advertisement for which a display requirement is to be determined, among a plurality of MR contents (MR advertisements) created in advance. At this time, the MR content acquiring unit 1101 also acquires, from the MR content manager 31, information on the size (display range), a display method, and display requester information (third information) of the MR advertisement. The display range is acquired based on the number of space IDs (counts in length, width, and height directions). The display method includes, similarly to the first embodiment, continuous display and movement of a space in which the MR advertisement is displayed.

After processing of steps S1201 and S403 to S405 is performed, processing of step S1202 is performed. In step S1202, the MR content generator 1102 changes the display range, display period, and display method of the MR advertisement acquired by the MR content acquiring unit 1101 in accordance with the display requirements of the MR advertisement determined by the MR advertisement determining unit 305. Thereby, the MR content (MR advertisement) to be presented to the MR advertisement display requester is generated, and this flow ends.

In a case where an MR advertisement is created in advance, this embodiment can obtain a display requirement of an MR advertisement in consideration of an influence on the visibility of a real advertisement, and further obtain an MR advertisement according to the display requirement.

### MODIFICATION 2-1

A desired space included in an MR advertisement request may be one or more real worlds, and a display requirement of an MR advertisement may be determined for each real world. In this case, influence determination in step S404 and determination of the display requirement of the MR advertisement in step S405 are performed for the plurality of real worlds. Thereby, the MR advertisement display requester can select a more appropriate real world and display requirement for displaying the MR advertisement.

### MODIFICATION 2-2

The MR content generator 1102 may generate an MR advertisement to be presented to the MR advertisement display requester by changing a display range, a display period, and a display method of the MR advertisement acquired by the MR content acquiring unit 1101 using generative AI.

The MR content generator 1102 may generate a new MR advertisement to be presented to the MR advertisement display requester without using the MR advertisement acquired by the MR content acquiring unit 1101.

Depending on the MR advertisement display requirement determined by the MR advertisement determining unit 305, the MR content generator 1102 may present the MR advertisement acquired by the MR content acquiring unit 1101 to the MR advertisement display requester without modification.

In each of the above embodiments, real display information and virtual display information are advertisements. However, the real display information and the virtual display information may be information other than advertisements, such as guidance, news, or video works.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment provides an information processing apparatus and an information processing method, each of which can properly determine the display requirement of virtual display information for the real world.

This application claims the benefit of Japanese Patent Application No. 2025-021986, filed on February 14, 2025, and which is hereby incorporated by reference herein in its entirety.

What is claimed is:

1. An information processing apparatus comprising:
one or more memories storing instructions; and
one or more processors that, upon execution of the instructions, operate to:
acquire first information on a real world,
acquire second information including at least information on a display right holder regarding real display information displayed in the real world,
acquire third information on a request for display of virtual display information superimposed on the real display information in the real world, and
determine a display requirement allowable by the display right holder for the virtual display information based on the first information, the second information, and the third information.

2. The information processing apparatus according to claim 1, wherein the virtual display information includes information different from the real display information.

3. The information processing apparatus according to claim 1, wherein the one or more processors operate to:
acquire information on an influence of the display of the virtual display information on the real display information based on the first information, the second information, and the third information, and
determine the display requirement based on the information on the influence.

4. The information processing apparatus according to claim 3, wherein the influence includes an influence on visibility of the real display information by a viewer.

5. The information processing apparatus according to claim 3, wherein the influence includes an influence on content of the real display information.

6. The information processing apparatus according to claim 3, wherein the influence includes an influence on a provider of the real display information.

7. The information processing apparatus according to claim 1, wherein the real display information and the virtual display information include an advertisement.

8. The information processing apparatus according to claim 1, wherein the first information includes:
any one of identification information, a space name, an owner, and an attribute of the real world, and
information indicating whether or not viewing by a viewer is possible in the real world.

9. The information processing apparatus according to claim 1, wherein the second information includes:
any one of a position, an orientation, and a size at which the real display information is displayed, and
at least one of a display requester of the real display information, the display right holder of the real display information, a display period of the real display information, and a permission condition for displaying the virtual display information at a same position as that of the real display information.

10. The information processing apparatus according to claim 1, wherein the third information includes:
any one of the real world and a display period for which the display of the virtual display information is requested, and
at least one of a display method requested for the display of the virtual display information, and a payable amount for requesting the display of the virtual display information.

11. The information processing apparatus according to claim 1, wherein the display requirement includes:
any one of a range of the real world and a display period in which the virtual display information is to be displayed, and
at least one of a position of a viewer who views the virtual display information, and a payment condition of a fee for the display of the virtual display information.

12. The information processing apparatus according to claim 1, wherein the one or more processors operate to generate the virtual display information in accordance with the display requirement.

13. An information processing method comprising:
acquiring first information on a real world,
acquiring second information including at least information on a display right holder regarding real display information displayed in the real world,
acquiring third information on a request for display of virtual display information superimposed on the real display information in the real world, and
determining a display requirement allowable by the display right holder for the virtual display information based on the first information, the second information, and the third information.

14. A non-transitory computer-readable storage medium storing a program that causes a computer to execute an information processing method comprising:
acquiring first information on a real world;
acquiring second information including at least information on a display right holder regarding real display information displayed in the real world;
acquiring third information on a request for display of virtual display information superimposed on the real display information in the real world; and
determining a display requirement allowable by the display right holder for the virtual display information based on the first information, the second information, and the third information.
